(19) United States
(12) Patent Application Publication
(10) Pub. No.: US 2010/0265213 A1
(43) Pub. Date: Oct. 21, 2010

(54) TOUCH LIQUID CRYSTAL DISPLAY AND OPERATING METHOD THEREOF

(75) Inventors: Po Yang CHEN, Tainan City (TW); Po Sheng SHIH, Hsinchu City (TW)

Correspondence Address: LOWE HAUPTMAN HAM & BERNER, LLP, 1700 DIAGONAL ROAD, SUITE 300, ALEXANDRIA, VA, 22314, US

(73) Assignee: HANNSTAR DISPLAY CORP., Taipei County (TW)

(21) Appl. No.: 12/762,044

(22) Filed: Apr. 16, 2010

(30) Foreign Application Priority Data
Apr. 20, 2009 (TW) 098112992

(51) Int. Cl. G06F 3/044

(52) U.S. Cl. 345/174

(57) ABSTRACT

A touch liquid crystal display includes a gate driver, a plurality of sensing units and a decision unit. The gate driver is configured to generate a scan signal. Each sensing unit includes a data read line, a liquid crystal capacitor, a first switching transistor, a second switching transistor and a third switching transistor. When the scan signal turns on the first switching transistor, a bias voltage charges the liquid crystal capacitor through the first switching transistor. When the scan signal turns on the third switching transistor, the bias voltage generates a dynamic current to the data read line through the third switching transistor and the second switching transistor. The decision unit determines whether the sensing unit is pressed or not according to the dynamic current; wherein a bias on the liquid crystal capacitor is zero when the first switching transistor is not turned on and the sensing unit is not pressed.

### CROSS REFERENCE TO RELATED APPLICATION

This application claims the priority benefit of Taiwan Patent Application Serial Number 098112992, filed on Apr. 20, 2009, the full disclosure of which is incorporated herein by reference.

### BACKGROUND

1. Field of the Invention

This invention generally relates to a liquid crystal display and, more particularly, to a touch liquid crystal display and an operating method thereof.

2. Description of the Related Art

In recent years, liquid crystal displays have become a major component of various electronic products. The appearance of the touch liquid crystal display further increases the use convenience of the liquid crystal display. In a conventional liquid crystal display, an extra touch panel is required and the coordinate of a touch point on the touch panel is identified by detecting the voltage variation caused by the touch point. However, the extra touch panel will increase the thickness and decrease the light transmittance of the liquid crystal display.

In order to solve the aforementioned problems, the industry proposed a liquid crystal display with integrated optical touch panel. In this kind of liquid crystal display, light detectors are embedded therein to detect the distribution of light in front of the display panel thereby detecting the location of a touch point on the display panel. However, since this kind of liquid crystal display identifies touch evens by detecting the variation of ambient light intensity, the identification mechanism needs to be set according to different operational environments. For example, since the ambient light intensity is apparently different in indoor and outdoor operational environments, the identification mechanism for touch events needs to be calibrated. Preferably, the identification mechanism for touch events can be calibrated dynamically and automatically according to the operational environments, such that the touch operation of the liquid crystal display can be more correct and convenient. However, the design complexity will be significantly increased.

FIG. 1 shows a schematic diagram of another kind of liquid crystal display with in-cell capacitive touch panel that includes a plurality of transversal and longitudinal detecting lines S_{T} and S_{L} configured to respectively read voltages of one row Vout(x) and one column Vout(y) of pixels in the liquid crystal panel. When the liquid crystal panel is pressed, the capacitance of the liquid crystal capacitor C_{LC} corresponding to a touch point will be changed so as to correspondingly change the voltages Vout(x) and Vout(y) detected. In this manner, a touch event can be detected and the coordinate of the touch point can be identified. However, this kind of liquid crystal display with in-cell capacitive touch panel has at least two problems: (1) As the detecting lines S_{T} and S_{L} have larger stray capacitance, this structure is not suitable to a large size panel; (2) As the value of ΔC_{LC}/C_{ref} (ΔC_{LC} is the capacitance variation of C_{LC}) will decrease with the increase of the panel size, it has lower sensitivity and accuracy.

Accordingly, the present invention provides a thin, light, small, high sensitivity, high accuracy and simple touch liquid crystal display.

### SUMMARY

The present invention provides a touch liquid crystal display and an operating method thereof that detects dynamic current variation caused by the variation of liquid crystal capacitance in each sensing unit so as to accurately detect the pressing position.

The present invention further provides a touch liquid crystal display and an operating method thereof, wherein when a sensing unit is not pressed, the liquid crystal capacitor in the sensing unit is operated at zero bias so as to increase the detection sensitivity.

The present invention provides a touch liquid crystal display including a gate driver, a plurality of sensing units arranged in a matrix and a decision unit. The gate driver is configured to generate a scan signal. Each sensing unit includes a data read line, a first gate line, a second gate line, a first switching transistor, a liquid crystal capacitor, a second switching transistor, a third switching transistor and a storage capacitor. The data read line is configured to output a dynamic current. The first gate line and the second gate line are coupled to the gate driver and sequentially receive the scan signal. The first switching transistor includes a control terminal coupled to the first gate line, a first terminal coupled to a node, and a second terminal coupled to a bias voltage. The liquid crystal capacitor is coupled to between the node and a common voltage. The second switching transistor includes a control terminal coupled to the node, and a first terminal coupled to the data read line. The third switching transistor includes a control terminal coupled to the second gate line, a first terminal coupled to the bias voltage, and a second terminal coupled to a second terminal of the second switching transistor. The storage capacitor is coupled to between the first gate line and the node. The decision unit is coupled to the data read line and determines whether the sensing unit is pressed or not according to the dynamic current; wherein a bias on the liquid crystal capacitor is zero when the first switching transistor is not turned on and the sensing unit is not pressed.

The present invention further provides a sensing unit of a touch liquid crystal display including a first gate line, a second gate line, a data read line, a liquid crystal capacitor, a first switching transistor, a second switching transistor, a third switching transistor, and a storage capacitor. The first gate line and the second gate line sequentially receive a scan signal. The data read line is configured to output a dynamic current. The first switching transistor includes a control terminal coupled to the first gate line, a first terminal coupled to a first terminal of the liquid crystal capacitor, and a second terminal coupled to a bias voltage. The second switching transistor includes a control terminal coupled to the first terminal of the liquid crystal capacitor, and a first terminal coupled to the data read line. The third switching transistor includes a control terminal coupled to the second gate line, a first terminal coupled to the bias voltage and a second terminal coupled to a second terminal of the second switching transistor. The storage capacitor is coupled to between the first terminal of the liquid crystal capacitor and the first gate line; wherein the dynamic current is for determining whether the sensing unit is pressed or not; and a bias on the liquid crystal capacitor is zero when the first switching transistor is not turned on and the sensing unit is not pressed.

The present invention further provides an operating method of a touch liquid crystal display. The touch liquid crystal display includes a plurality of sensing units arranged in a matrix. Each sensing unit includes a first gate line and a second gate line sequentially receiving a scan signal; a liquid crystal capacitor; a first switching transistor comprising a control terminal coupled to the first gate line, a first terminal coupled to a first terminal of the liquid crystal capacitor, and a second terminal coupled to a bias voltage; a second switching transistor comprising a control terminal coupled to the first terminal of the liquid crystal capacitor, and a first terminal outputting a dynamic current; and a third switching transistor comprising a control terminal coupled to the second gate line, a first terminal coupled to the bias voltage, and a second terminal coupled to a second terminal of the second switching transistor. The operating method includes the steps of: within a first time interval, turning on the first switching transistor with the scan signal through the first gate line to allow the bias voltage to charge the liquid crystal capacitor; within a second time interval, turning off the first switching transistor with the scan signal through the first gate line to allow the liquid crystal capacitor to change the voltage thereof; within a third time interval, turning on the third switching transistor with the scan signal through the second gate line to allow the bias voltage to generate the dynamic current through the second and third switching transistors; and determining whether a sensing unit is pressed or not according to the dynamic current, wherein when the sensing unit is not pressed, a bias on the liquid crystal capacitor is discharged to zero in the second time interval.

The aforementioned touch liquid crystal display further includes an array substrate and a color filter substrate, wherein the bias voltage may be coupled to a common voltage of the array substrate while the common voltage may be coupled to a common voltage of the color filter substrate. The bias voltage is higher than the common voltage by a predetermined voltage difference such that when the sensing unit of the touch liquid crystal display is not pressed, the liquid crystal capacitor is zero biased, wherein the predetermined voltage difference may be determined according to a peak-to-peak value of the scan signal, a value of the liquid crystal capacitor and a value of the storage capacitor.

### BRIEF DESCRIPTION OF THE DRAWINGS

Other objects, advantages, and novel features of the present invention will become more apparent from the following detailed description when taken in conjunction with the accompanying drawings.

FIG. 1 shows a partial circuit diagram of a conventional liquid crystal touch panel.

FIG. 2a shows a schematic diagram of liquid crystal molecules in a liquid crystal display driven by a non-zero bias.

FIG. 2b shows a schematic diagram of liquid crystal molecules in a liquid crystal display driven by a zero bias.

FIG. 2c shows a schematic diagram of a liquid crystal display pressed by an external force.

FIG. 3 shows a block diagram of the touch liquid crystal display in accordance with an embodiment of the present invention.

FIG. 4 shows a partial circuit diagram of a sensing unit of the touch liquid crystal display in accordance with an embodiment of the present invention.

FIG. 5 shows an operational timing diagram of a sensing unit of the touch liquid crystal display in accordance with an embodiment of the present invention.

FIG. 6a shows an operational diagram of a sensing unit within a first time interval of the touch liquid crystal display in accordance with an embodiment of the present invention.

FIG. 6b shows an operational diagram of a sensing unit within a second time interval of the touch liquid crystal display in accordance with an embodiment of the present invention.

FIG. 6c shows an operational diagram of a sensing unit within a third time interval of the touch liquid crystal display in accordance with an embodiment of the present invention.

FIG. 7 schematically shows conducting states of the switching transistors within different time intervals in a sensing unit of the touch liquid crystal display in accordance with an embodiment of the present invention.

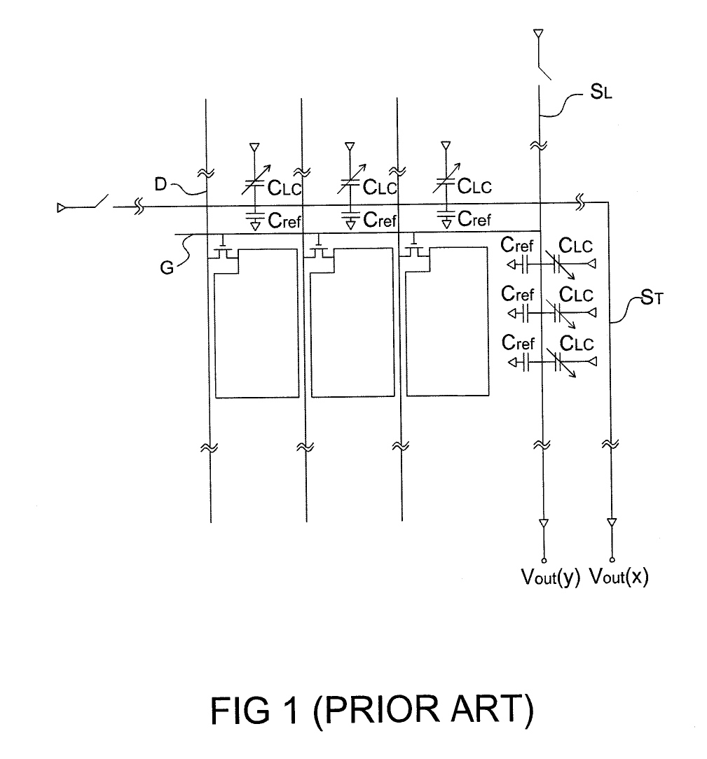

### DETAILED DESCRIPTION OF THE EMBODIMENT

It should be noticed that, wherever possible, the same reference numbers will be used throughout the drawings to refer to the same or like parts.

First of all, the basic principle of the present invention will be illustrated. In a liquid crystal display with in-cell capacitive touch panel, the detection sensitivity and accuracy can be increased by increasing the capacitance variation when the panel is being pressed.

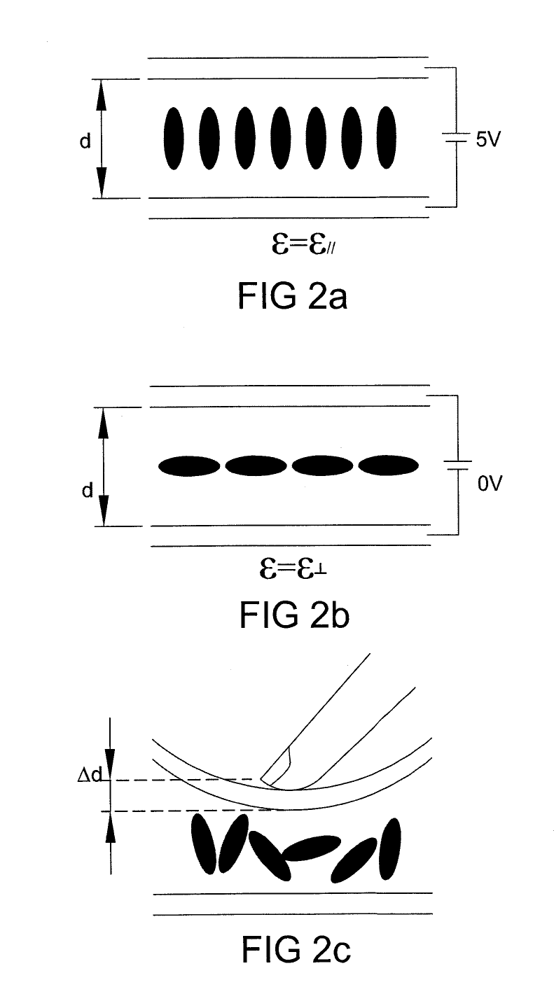

Please refer to FIGS. 2a to 2c, they respectively show a schematic diagram of a liquid crystal display that includes two transparent substrates and a plurality of liquid crystal molecules sandwiched between the two transparent substrates. For simplification, FIGS. 2a to 2c omit other components. FIG. 2a shows a schematic diagram of liquid crystal molecules between two transparent substrates biased by a 5V bias voltage, and herein it is summed that an equivalent dielectric constant of the liquid crystal molecules is ε_{//}. FIG. 2b shows a schematic diagram of liquid crystal molecules between two transparent substrates biased by a 0V bias voltage (i.e. zero bias), and herein it is summed that an equivalent dielectric constant of the liquid crystal molecules is ε_{⊥}. FIG. 2c shows a distance variation Δd that is caused by an external force pressing on the upper transparent substrate, and herein it is assumed that an equivalent dielectric constant is equal to ε=(ε_{//}+2ε_{⊥})/3, wherein ε_{//}>ε>ε_{⊥}.

According to the capacitance formula, C=εA/d, wherein A is an area of the upper and lower transparent substrates, d is a distance between the two transparent substrates, and C is the capacitance of a liquid crystal capacitor, when the liquid crystal display is pressed by an external force at non-zero bias condition (i.e. changing from FIG. 2a to FIG. 2c), the distance d between two transparent substrates will decrease thereby increasing the capacitance. But because the equivalent dielectric constant will change from ε_{//} to s at the same time to decrease the capacitance, lower capacitance variation will be obtained due to the cancellation of two effects. On the other hand, when the liquid crystal display is pressed by an external force at zero bias condition (i.e. changing from FIG. 2b to FIG. 2c), the equivalent dielectric constant will change from ε_{⊥} to ε thereby increasing the capacitance. In conjunction with the increase of capacitance due to the decrease of distance d, larger capacitance variation will be obtained. The present invention utilizes this characteristic to provide a touch liquid crystal display. When the liquid crystal display is not pressed by an external force, the liquid crystal capacitor of each sensing unit will work at zero bias so as to increase the detection sensitivity thereof.

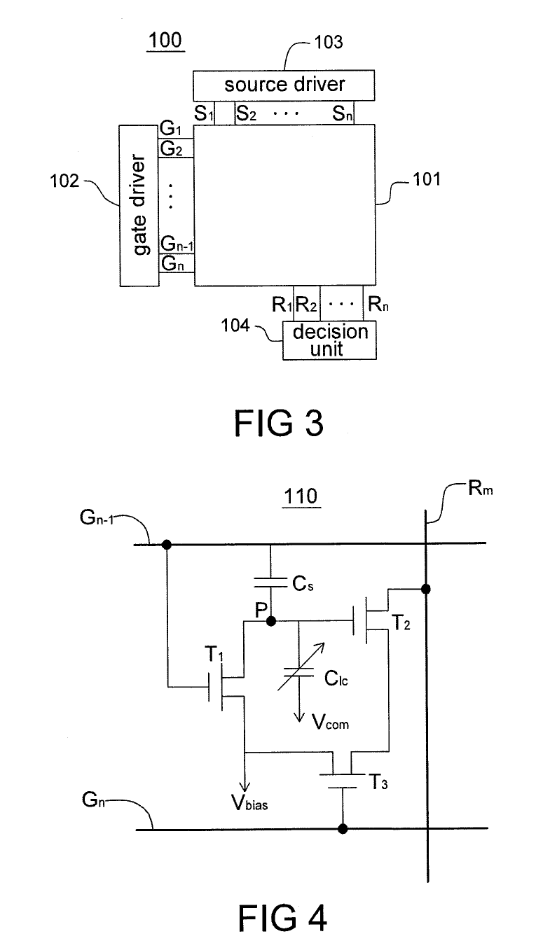

Please refer to FIG. 3, it shows a block diagram of the touch liquid crystal display 100 in accordance with an embodiment of the present invention, which includes a liquid crystal panel 101, a gate driver 102, a source driver 103 and a decision unit 104. The liquid crystal panel 101 includes a plurality of sensing units 110 arranged in a matrix (as shown in FIG. 4) and a plurality of pixel units (not shown). The gate driver 102 is coupled to the liquid crystal panel 101 through a plurality of gate lines G₁˜Gₙ, and each gate line is coupled to a row of sensing units and pixel units. The gate driver 102 transmits a scan signal through the gate lines G₂˜Hₙ so as to sequentially drive every row of sensing units and pixel units of the liquid crystal panel 101. The source driver 103 is coupled to the liquid crystal panel 101 through a plurality of source lines S₂˜Sₙ, and each source line is coupled to a column of sensing units and pixel units. The source driver 103 provides required voltages during display to every column of pixel units of the liquid crystal panel 101 through the source lines S₁˜Sₙ. The decision unit 104 receives a dynamic current generated by the voltage variation of the liquid crystal capacitor in every sensing units through a plurality of data read lines R₁˜Rₙ so as to identify whether there is any sensing unit is pressed and to identify the location of the sensing unit being pressed, wherein before the sensing unit is pressed the liquid crystal capacitor of the sensing unit is zero biased. In addition, it should be appreciated that the location of the decision unit 104 shown in FIG. 3 is not a limitation of the present invention.

Please refer to FIG. 4, it shows a schematic diagram of a sensing unit 110 of the touch liquid crystal display 100 in accordance with an embodiment of the present invention, which includes a first switching transistor T₁, a second switching transistor T₂, a third switching transistor T₃, a storage capacitor Cₛ, a liquid crystal capacitor C_{lc}, two adjacent gate lines Gₙ₋₁, Gₙ and a data read line Rₘ. A control terminal of the first switching transistor T₁ is coupled to the gate line Gₙ₋₁; a first terminal of the first switching transistor T₁ is coupled to a first node P; and a second terminal of the first switching transistor T₁ is coupled to a bias voltage V_{bias}, e.g. the common voltage of a stray substrate (not shown) of the touch liquid crystal display 100. A control terminal of the second switching transistor T₂ is coupled to the node P; and a first terminal of the second switching transistor T₂ is coupled to the data read line Rₘ. A control terminal of the third switching transistor T₃ is coupled to the gate line Gₙ; a first terminal of the third switching transistor T₃ is coupled to the second terminal (and the bias voltage V_{bias}) of the first switching transistor T₁; and a second terminal of the third switching transistor T₃ is coupled to a second terminal of the second switching transistor T₂. A first terminal of the storage capacitor Cₛ is coupled to the gate line Gₙ₋₁; and a second terminal of the storage capacitor Cₛ is coupled to the node P. A first terminal of the liquid crystal capacitor C_{lc} is coupled to the node P; and a second terminal of the liquid crystal capacitor C_{lc} is coupled to a common voltage V_{com}, e.g. the common voltage of a color filter substrate (not shown) of the touch liquid crystal display 100. As mentioned above, in the present invention, the decision unit 104 reads a dynamic current through the data read line Rₘ. When the first switching transistor T₁ is not turned on and the sensing unit 110 is not being pressed, the liquid crystal capacitor C_{lc} is operated at zero bias condition. When the sensing unit 110 is being pressed by a finger or a touch pen, a distance between two electrodes of the liquid crystal capacitor C_{lc} is decreased and an equivalent dielectric constant is increased, so the capacitance of the liquid crystal capacitor C_{lc} is significantly increased. Furthermore, in order to allow the liquid crystal capacitor C_{lc} to be able to operate at zero-biased condition, the bias voltage V_{bias} is set to be higher than the common voltage by a predetermined voltage difference, as show in equation (1)

V_{bias}=V_{com}+ΔV_{g}×(Cₛ/(C_{lc}(0))+Cₛ) (1)

Wherein ΔV_{g} is a peak-to-peak value of the scan signal, and C_{lc}(0) is the capacitance of the liquid crystal capacitor C_{lc} at zero bias condition.

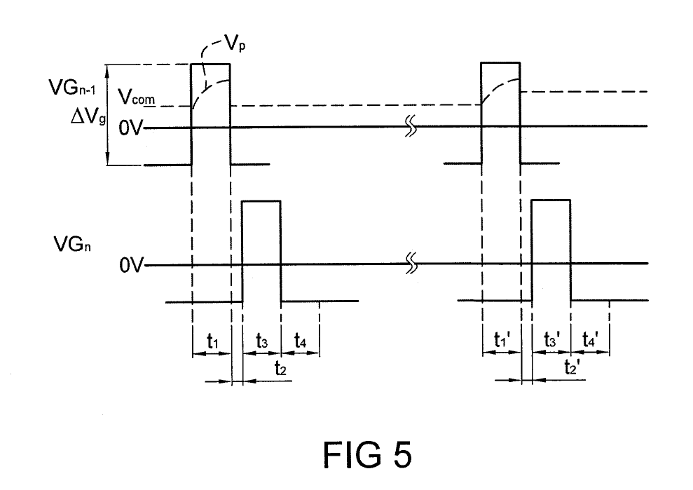

Please refer to FIG. 5, it shows an operational timing diagram of the touch liquid crystal display 100 in accordance with an embodiment of the present invention, wherein the gate line Gₙ₋₁ receives a scan signal within a first time interval t₁. Next, after a second time interval t₂, the gate line Gₙ receives the scan signal within a third time interval t₃. Within a fourth time interval t₄, the gate driver 102 transmits the scan signal to the next gate line (a gate line Gₙ₊₁ or the first gate line). As shown in FIG. 5, the peak-to-peak value of the scan signal is set as ΔV_{g}. It could be understood that, after the scan signal finishes one cycle (accomplishing scanning all scan lines), the gate lines Gₙ₋₁ and Gₙ will receive the scan signal again as shown in time intervals t₁′˜t₄′, i.e. the gate lines Gₙ₋₁ and Gₙ will periodically receive a scan signal in a fixed cycle. The dash line shown in FIG. 5 is the voltage Vₚ of the node P in the sensing unit 110.

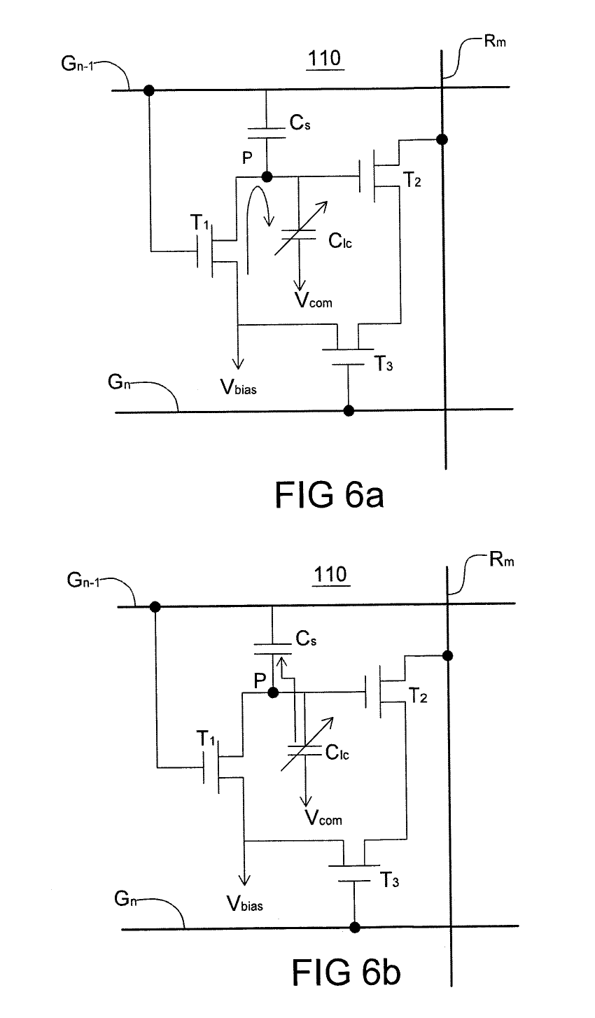

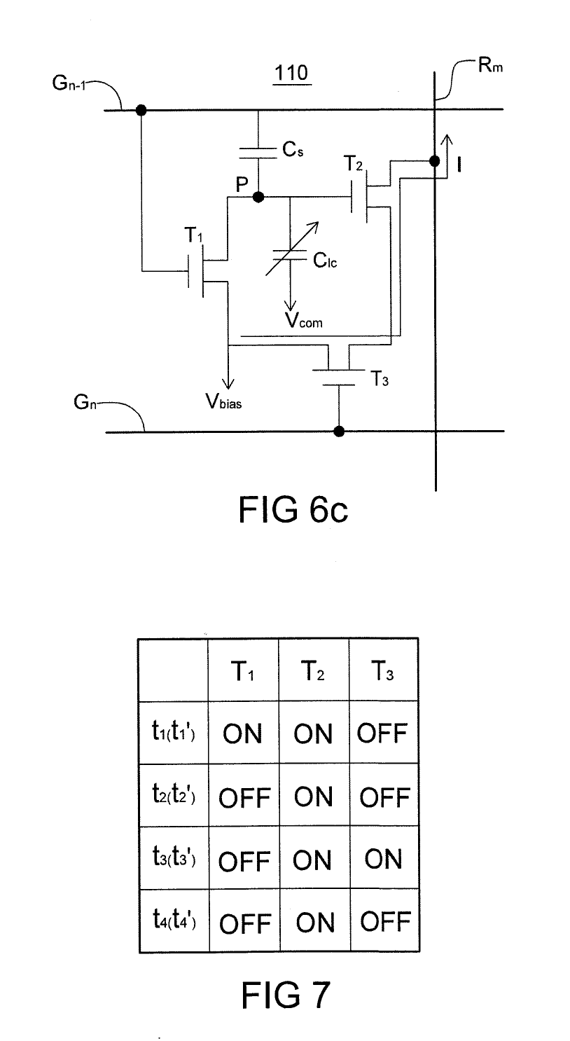

Please refer to FIGS. 6a to 6c, they schematically show operational diagrams of the sensing unit 110 with respective to different time intervals shown in FIG. 5. FIG. 6a shows an operational diagram within the first time interval t₁; FIG. 6b shows an operational diagram within the second time interval t₂; and FIG. 6c shows an operational diagram within the third time interval t₃. Furthermore, for illustration purpose, FIG. 7 shows the conducting states of the switching transistors T₁˜T₃ for every time interval t₁˜t₄ (t₁′˜t₄′).

Please refer to FIGS. 5 to 7 together, the operating method of the touch liquid crystal display 100 of the present invention will be illustrated hereinafter. It is assumed that the sensing unit 110 is not pressed before the first time interval t₁, and thus the bias on the node P is equal to the common voltage V_{com}. Within the first time interval t₁, the gate line Gₙ₋₁ receives a scan signal, whose maximum voltage may be 16 volts and minimum voltage may be −8 volts. At this moment, the switching transistor T₁ is turned on and the bias voltage V_{bias} (e.g. 17 volts) charges the liquid crystal capacitor C_{lc} (FIG. 6a). In addition, within the first time interval t₁, the second switching transistor T₂ is turned on and the third switching transistor T₃ is turned off. The common voltage V_{com} may be, for example, 5 volts.

The second time interval t₂ is an interval between the gate driver 102 driving the gate lines Gₙ₋₁ and Gₙ, i.e. the gate lines Gₙ₋₁ and Gₙ neither receiving the scan signal. At this moment, the first switching transistor T₁ and the third switching transistor T₃ are not turned on (FIG. 6b). Within the second time interval t₂, the voltage variation of the gate line Gₙ₋₁ is ΔV_{g}, e.g. from 16 volts to −8 volts. According to the capacitance coupling effect, part of charges in the liquid crystal capacitor C_{lc} will be released to the storage capacitor Cₛ, and a voltage variation of the liquid crystal capacitor C_{lc} may be obtained as ΔV_{g}×(Cₛ)(C_{lc})+Cₛ). According to equation (1), the voltage of the node P will change to V_{com}, whereby the liquid crystal capacitor C_{lc} may operate at zero bias.

Within the third time interval t₃, the gate line Gₙ receives the scan signal to turn on the third switching transistor T₃ (FIG. 6c). At this moment, the gate line Gₙ₋₁ does not receive the scan signal, and thus the first switching transistor T₁ is turned off The second switching transistor T₂ is turned on according to the voltage of the node P. In this manner, a dynamic current I flows from the bias voltage V_{bias} to sequentially flow through the third switching transistor T₃, the second switching transistor T₂ and the data read line Rₘ and then be read by the decision unit 104, and the value of the dynamic current I is determined according to the voltage coupled to the control terminal of the second switching transistor T₂ (i.e. the voltage of the node P). The decision unit 104 determines whether the sensing unit 110 is pressed or not according to the value of the dynamic current I.

Within the fourth time interval t₄, the gate driver 102 transmits the scan signal to a gate line next to the gate line Gₙ (i.e. gate line Gₙ₊₁ or the first gate line) to finish the operating procedure of one sensing unit.

Please refer to FIG. 5 again, after a scan cycle, the gate line Gₙ₋₁ will receive a scan signal again, e.g. time intervals t₁′˜t₄′. At this moment, it is assumed that the sensing unit 110 is pressed by an external force such that the capacitance of the liquid crystal capacitor is increased from C_{lc} to C_{lc}′, wherein C_{lc}′>C_{lc}. The operation of the sensing unit 110 within the time interval t₁′ is identical to that within the time interval t₁, so details will not be repeated herein.

Within the time interval t₂′, the gate lines Gₙ₋₁ and Gₙ do not receive the scan signal, and thus the first switching transistor T₁ and the second switching transistor T₂ are not turned on (FIG. 6b). At this moment, the voltage variation of the gate line Gₙ₋₁ is ΔV_{g}, e.g. from 16 volts to −8 volts. According to the capacitance coupling effect, the liquid crystal capacitor C_{lc}′ releases part of charges therein to the storage capacitor Cₛ, and the voltage variation of the liquid crystal capacitor C_{lc}′ is equal to ΔV_{g}×(Cₛ/(C_{lc}′)+Cₛ). According to equation (1) and the condition C_{lc}′>C_{lc}, the voltage of the node P will be higher than the common voltage V_{com} as shown in FIG. 5. In this manner, within the third time interval t₃′, as the control terminal of the second switching transistor T₂ is coupled to a higher voltage, the decision unit 104 may read a higher dynamic current I and accordingly identifies that the sensing unit 110 is being pressed by an external force. Within the fourth time interval t₄′, since the external force pressing on the sensing unit 110 has not been removed, the voltage Vₚ of the node P is still at a higher level.

As mentioned above, the conventional liquid crystal display with in-cell capacitive touch panel has lower accuracy and sensitivity. The present invention detects the voltage variation of the liquid crystal capacitor, and since the liquid crystal capacitor is operated at zero bias condition while not being pressed, the voltage variation can be significantly increased. In this manner, the present invention can increase the sensitivity and accuracy to identify a touch point.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A touch liquid crystal display, comprising:
a gate driver, configured to generate a scan signal;
a plurality of sensing units arranged in a matrix, each sensing unit comprising:
a data read line, configured to output a dynamic current;
a first gate line and a second gate line, coupled to the gate driver and sequentially receiving the scan signal;
a first switching transistor, comprising a control terminal coupled to the first gate line, a first terminal coupled to a node, and a second terminal coupled to a bias voltage;
a liquid crystal capacitor, coupled to between the node and a common voltage;
a second switching transistor, comprising a control terminal coupled to the node, and a first terminal coupled to the data read line;
a third switching transistor, comprising a control terminal coupled to the second gate line, a first terminal coupled to the bias voltage, and a second terminal coupled to a second terminal of the second switching transistor; and
a storage capacitor, coupled to between the first gate line and the node; and
a decision unit, coupled to the data read line and determining whether the sensing unit is pressed or not according to the dynamic current;
wherein a bias on the liquid crystal capacitor is zero when the first switching transistor is not turned on and the sensing unit is not pressed.

2. The touch liquid crystal display as claimed in claim 1, further comprising a color filter substrate, wherein the common voltage is a common voltage of the color filter substrate.

3. The touch liquid crystal display as claimed in claim 1, wherein the bias voltage is higher than the common voltage by a predetermined voltage difference, such that the bias on the liquid crystal capacitor is zero when the first switching transistor is not turned on and the sensing unit is not pressed.

4. The touch liquid crystal display as claimed in claim 3, wherein the predetermined voltage difference is determined according to values of the liquid crystal capacitor and the storage capacitor.

5. The touch liquid crystal display as claimed in claim 1, wherein when the scan signal turns on the third switching transistor, the bias voltage generates the dynamic current through the third and second switching transistors.

6. A sensing unit of a touch liquid crystal display, comprising:
a first gate line and a second gate line, sequentially receiving a scan signal;
a data read line, configured to output a dynamic current;
a liquid crystal capacitor;
a first switching transistor, comprising a control terminal coupled to the first gate line, a first terminal coupled to a first terminal of the liquid crystal capacitor, and a second terminal coupled to a bias voltage;
a second switching transistor, comprising a control terminal coupled to the first terminal of the liquid crystal capacitor, and a first terminal coupled to the data read line;
a third switching transistor, comprising a control terminal coupled to the second gate line, a first terminal coupled to the bias voltage and a second terminal coupled to a second terminal of the second switching transistor; and
a storage capacitor, coupled to between the first terminal of the liquid crystal capacitor and the first gate line;
wherein the dynamic current is for determining whether the sensing unit is pressed or not; and a bias on the liquid crystal capacitor is zero when the first switching transistor is not turned on and the sensing unit is not pressed.

7. The sensing unit of a touch liquid crystal display as claimed in claim 6, wherein the liquid crystal capacitor further has a second terminal coupled to a common voltage.

8. The sensing unit of a touch liquid crystal display as claimed in claim 7, wherein the common voltage is a common voltage of a color filter substrate.

9. The sensing unit of a touch liquid crystal display as claimed in claim 6, wherein the bias voltage is higher than the common voltage by a predetermined voltage difference, such that the bias on the liquid crystal capacitor is zero when the first switching transistor is not turned on and the sensing unit is not pressed.

10. The sensing unit of a touch liquid crystal display as claimed in claim 9, wherein the predetermined voltage difference is determined according to values of the liquid crystal capacitor and the storage capacitor.

11. The sensing unit of a touch liquid crystal display as claimed in claim 6, wherein when the scan signal turns on the third switching transistor, the bias voltage generates the dynamic current through the third and second switching transistors.

12. An operating method of a touch liquid crystal display, the touch liquid crystal display comprising a plurality of sensing units arranged in a matrix, each sensing unit comprising a first gate line and a second gate line sequentially receiving a scan signal; a liquid crystal capacitor; a first switching transistor comprising a control terminal coupled to the first gate line, a first terminal coupled to a first terminal of the liquid crystal capacitor, and a second terminal coupled to a bias voltage; a second switching transistor comprising a control terminal coupled to the first terminal of the liquid crystal capacitor, and a first terminal outputting a dynamic current; and a third switching transistor comprising a control terminal coupled to the second gate line, a first terminal coupled to the bias voltage, and a second terminal coupled to a second terminal of the second switching transistor, the operating method comprising the steps of:
within a first time interval, turning on the first switching transistor with the scan signal through the first gate line to allow the bias voltage to charge the liquid crystal capacitor;
within a second time interval, turning off the first switching transistor with the scan signal through the first gate line to allow the liquid crystal capacitor to change the voltage thereof;
within a third time interval, turning on the third switching transistor with the scan signal through the second gate line to allow the bias voltage to generate the dynamic current through the second and third switching transistors; and
determining whether a sensing unit is pressed or not according to the dynamic current, wherein when the sensing unit is not pressed, a bias on the liquid crystal capacitor is discharged to zero in the second time interval.

13. The operating method as claimed in claim 11, wherein each sensing unit further comprises a storage capacitor, and within the second time interval, the liquid crystal capacitor discharges to the storage capacitor to allow the liquid crystal capacitor to change the voltage thereof.

14. The operating method as claimed in claim 11, wherein the liquid crystal capacitor further has a second terminal coupled to a common voltage of a color filter substrate.

15. The operating method as claimed in claim 11, wherein each sensing unit further comprises a data read line to receive the dynamic current.
